(19) United States
(12) Patent Application Publication
(10) Pub. No.: US 2020/0072701 A1
(43) Pub. Date: Mar. 5, 2020

(54) DETECTION SYSTEM OF A FUNCTIONAL FAILURE OF MICROMIRRORS IN A DMD MIRROR UNIT, ESPECIALLY IN A PROJECTOR SYSTEM OF A MOTOR VEHICLE HEADLIGHT

(71) Applicant: Varroc Lighting Systems, s.r.o., Senov u Noveho Jicina (CZ)

(72) Inventors: Martin Svrcek, Dobra (CZ); Vojtech Kresta, Ostrava - Vitkovice (CZ); Martin Bukovan, Dobra (CZ)

(21) Appl. No.: 16/552,457

(22) Filed: Aug. 27, 2019

(30) Foreign Application Priority Data
Aug. 30, 2018 (CZ) PV 2018-439

(51) Int. Cl. G01M 11/00; F21S 41/675; F21S 41/365; G02B 26/08; G01N 21/31

(52) U.S. Cl. CPC G01M 11/005; F21S 41/675; G01N 21/31; G02B 26/0833; F21S 41/365

(57) ABSTRACT

The detection system comprises a light unit to emit light, a primary optical unit to process light, a main light stream exiting therefrom directed to the mirror unit comprising micromirrors arranged in a rotary way whose angle of rotation is controlled by the control system so that light intended to produce a light image at a particular moment is reflected by the respective micromirrors, while the part of the light that shouldn't be used to produce the light image at the particular moment is reflected by other micromirrors into an absorption unit, from where light rays continue into the detection unit with an optical sensor to detect light rays, and a control unit to process the signal from the optical sensor, to evaluate whether the established condition corresponds to the pre-established light characteristic that the respective micromirror (or group(s) thereof) would exhibit during its faultless activity.

### RELATED APPLICATIONS

This application claims the priority benefit of Czech Patent Application Serial No. PV2018-439 entitled “A detection system of a functional failure of micromirrors in a DMD mirror unit, especially in a projector system of a motor vehicle headlight”, filed Aug. 30, 2018, the entire disclosure of which is incorporated herein by reference.

### FIELD OF THE INVENTION

The invention relates to a detection system of an operational failure of micromirrors in a DMD mirror unit, especially in a projector system for a motor vehicle headlight, adapted to adjust the required output characteristic of the light trace in specific zones in front of the driver on the carriageway.

### BACKGROUND INFORMATION

A headlight, especially for motor vehicles, contains at least one optical system comprising a powerful light source (or possibly more sources) and optical elements. The light source emits light rays and the optical elements represent a system of refractive and reflective surfaces, interfaces of optical environments and diaphragms that influence the direction of light rays within the creation of the output light trace.

In modern headlights of motor vehicles, projector systems are used wherein the light characteristics of the output light beam are dynamically changed depending on the conditions where the vehicle is found. Some projector systems comprise light units comprising a DMD (Digital Micromirror Device) mirror unit. The mirror unit comprises thousands of mirrors of microscopic dimensions wherein each of the mirrors represents at least one specific zone/point of the required output characteristic of the light trace in front of the driver on the carriageway. The source of light is generally a semiconductor diode (diodes), e.g. LED. The generated light passes through the primary optical system, or optical member, e.g. a lens that directs light onto the mirrors of the DMD array. The movement of the mirrors on the chip is precisely synchronized wherein light is sent to at least one secondary optical system to produce the output light image. If a part of the light needs to be unused to create an unlit zone/point in the output light image, the light device comprises an “absorber” that is adapted to convert light energy to thermal energy.

A solution is known from the document U.S. Pat. No. 4,868,721 that contains an assembly of rotary/oscillating micromirrors that makes it possible to influence the resulting image in two directions, wherein the light source is a laser diode. Between the laser diode and the mirror, a light modulator is situated making it possible to influence the light characteristics of the laser beams of rays or to even entirely interrupt the laser beam of rays. A disadvantage of this system is the fact that detection of proper functionality of the system is not made possible. A light device is known from the document US20020196636A1 that comprises a detection/diagnostic system of individual electronic components, but the detection system does not support detection of faulty/non-functioning mirrors or a certain assembly of mirrors comprising at least one faulty/non-functioning mirror.

A lighting device is known from the document DE102016200590A1 wherein the primary light unit/primary optical system is designed to emit light towards a deflector/oscillation mirror to deflect/diffuse light rays, the light in the form of a stream of light rays being further directed to the secondary optical system adapted to produce the required output image. A divider of light rays is incorporated in the secondary optical system, adapted to divide a part of the light deflected by the deflector to an image sensor. The image sensor is adapted to detect light rays deflected by the divider and to provide an output signal to an evaluation device configured to detect a failure of the lighting device as soon as the output signal provided by the image sensor deviates from a preset value. A disadvantage of this solution is that light designed to produce the required output light image or that could be used to produce the output light image is used for the detection of a failure of the lighting device.

The document DE102016209645A1 discloses a lighting device comprising at least one light source in the primary optical system to send light to a mirror device comprising at least one positionally adjustable mirror. The movement of each mirror is controlled (with the use of static energy) in such a manner that it can rotate around its central axis in parallel to its mirror surface, into various operational states. An actuator or actuators are driven by a control device while a mirror can be positioned by the actuator into a defined first state. In this first state, the light of the lighting device is especially directed to the secondary optical system. The mirror can be positioned into a second state. In this second state, the mirror directs light towards an absorber. In this absorber, light produced by the lighting device is absorbed, i.e. light is converted to heat. Thus, in the second rotary state of the mirror, light should not be sent outside the inner space of the lighting device. A sensor is located in a position between the first and second state of the mirror. This sensor detects at least a part of the light that is directed by the mirror during its positioning between the first and second rotary state. The image sensor is adapted to detect a failure of the lighting device and/or the mirror device with a mirror. A disadvantage of this device is that there are in fact three optical ways, namely to the secondary optical system, to the absorber and to the sensor. This makes the device difficult to adjust, it requires a large installation place and a relatively high number of optical elements. Thus, the optical system is more demanding to produce.

The object of the present invention is to remedy the above-mentioned drawbacks of the prior art, i.e. a light device, especially the projector system of a headlight for motor vehicles equipped with positionally adjustable micromirrors, wherein the light characteristics of the output light beam dynamically change depending on the conditions where the vehicle is found. The projector system must comprise a reliable detection system enabling detection of faulty/non-functioning mirrors or a certain assembly of mirrors comprising at least one faulty/non-functioning mirror, while the entire optical system must be optically efficient with low production demands.

### SUMMARY OF THE INVENTION

The object of the invention is met by a detection system of a functional failure of micromirrors in a DMD mirror unit, especially in the projector system of a motor vehicle headlight, comprising a light unit to emit coherent or incoherent light, a primary optical unit for light processing that at least one main light stream exits from that is directed to the mirror unit comprising micromirrors arranged in a rotary way, whose angle of rotation is controlled by the control system in such a way that the light that is intended to produce a light image at a particular moment is reflected by the respective micromirrors out of the mirror unit in the form of the primary light stream, while the part of the light that should not be used to produce the light image at the particular moment is reflected by other micromirrors in the form of the secondary light stream into an absorption unit. The absorption unit is configured for the output of at least a part of light rays that are directed to it by the mirror unit into the detection unit comprising an optical sensor to detect light rays, and a control unit connected to the control system to process and evaluate the signal from the optical sensor, in a defined scanning sequence in which individual micromirrors or simultaneously entire groups of micromirrors are rotated by the control system to establish a functional failure of an individual rotated micro-mirror or a functional failure of some micromirrors from the rotated group of micromirrors if it concludes that a state established by the optical sensor does not correspond to a pre-established light characteristic that the respective micromirror or group of micromirrors would exhibit in its perfectly functional state.

In one of the embodiments, the control unit is part of the control system.

In another one of the embodiments, the control unit is part of the detection unit.

In another one of the embodiments, the absorption unit comprises a tertiary optical system comprising at least one diffractive optical element to direct light rays from the tertiary optical system partly to the absorber, and partly to the detection unit.

In another one of the embodiments, the absorption unit comprises a tertiary optical system comprising at least one diffractive optical element to direct light rays from the tertiary optical system to the absorber, a part of light rays received by the absorption unit being sent to the detection unit from it.

### BRIEF DESCRIPTION OF THE DRAWINGS

The invention will be clarified in a more detailed way with the use of its embodiment examples with references to attached drawings, where:

FIG. 1 shows a schematic diagram of an embodiment example of the detection system of a functional failure of micromirrors in a DMD mirror unit, used in a projector system of a motor vehicle headlight, according to the invention, and

FIG. 2 shows a schematic diagram of another embodiment example of the detection system, according to the invention.

### EXAMPLES OF EMBODIMENTS OF THE INVENTION

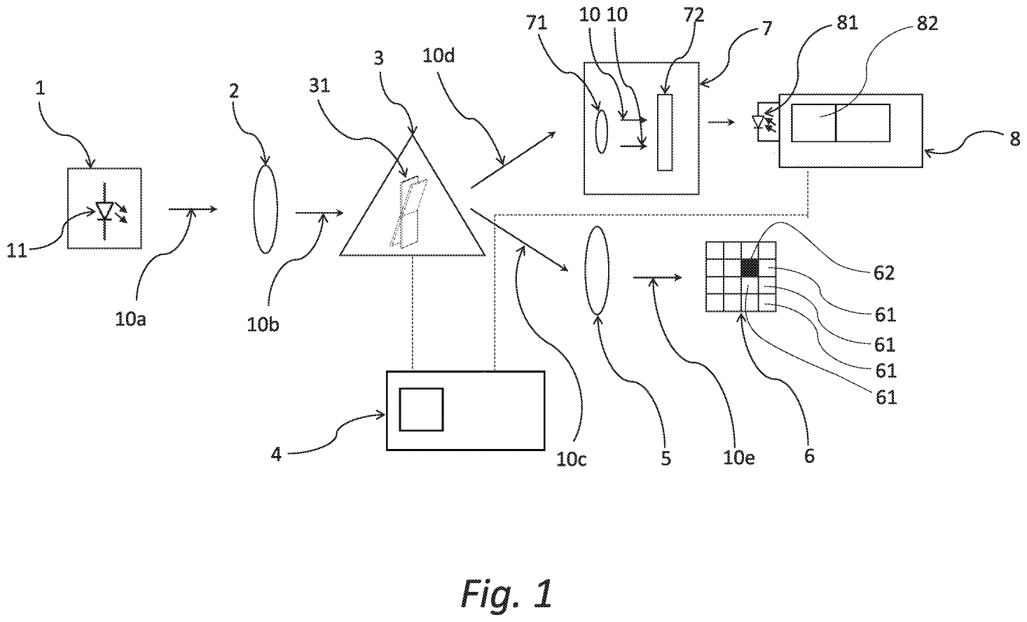

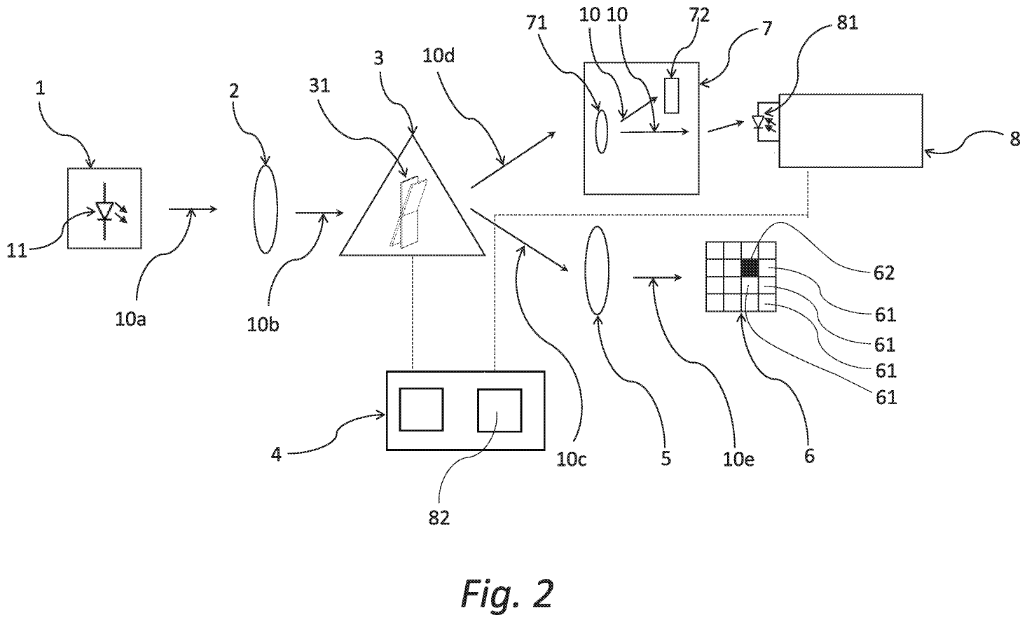

FIGS. 1 and 2 show two embodiment examples of the detection system of a failure of micromirrors in a DMD mirror unit, used in a projector system of a motor vehicle headlight, according to the invention. The detection system comprises a light unit 1 with one or more diodes 11 to create coherent or incoherent light 10a, and a primary optical system 2 adapted by means of at least one diffractive optical element to produce at least one main light stream 10b directed to the mirror unit 3. The mirror unit 3 represents a micro-optical-electro-mechanical-system (DMD—Digital Micromirror Device) designed, through the control system 4, to change the rotary position of the micromirrors 31 and to produce the primary light stream 10c and the secondary light stream 10d.

In the propagation direction of the primary light stream 10c, the secondary optical system 5 is situated comprising at least one diffractive optical element to direct the output light stream 10e out of the light device and to produce a light image 6 consisting of multiple segments 61. The appearance of each segment 61 influences the overall appearance of the light image 6. On the other hand, the segments 61 represent the smallest units the appearance of which can be influenced, i.e. for instance an unlit part cannot be created within a single segment 61 of the resulting light image 6. If an unlit part 62 is to be produced in the light image 6, a part of the main light stream 10b is sent by the mirror unit 3 into the absorption unit 7 in the form of the secondary light stream 10d.

In the first embodiment of FIG. 1, the absorption unit 7 comprises a tertiary optical system 71 comprising at least one diffractive optical element to direct light rays 10 coming from the tertiary optical system 71 to the absorber 72, a part of light rays 10 received by the absorber 72 being sent to the detection unit 8. The absorber 72 can, e.g., work as a filter that reduces the intensity of light that is further sent/focused onto the sensor 81. The detection unit 8 comprises an optical sensor or sensors 81, e.g., a photo-diode (or an array of photo-diodes) and a detection control unit 82.

As shown in the embodiment example of FIG. 2, the control unit 82 can be part of the control system 4 (i.e. the control system of the DMD) controlling the mirror unit 3. In this example, a part of light exiting from the tertiary optical system 71 is directed to the absorber 72 while another part of light exiting from the tertiary optical system 71 is directed to the optical sensor 81.

The detection control unit 82 processes and evaluates the signal from the sensor/s 81 (advantageously from a photo-diode or an array of photo-diodes) based on a defined scanning sequence wherein individual micromirrors 31 or entire groups of micromirrors 31 are rotated through the control system 4. Within the process, data obtained for a particular rotated micromirror 31 or group of micromirrors 31 from the sensor 81 are compared to the light characteristic that would correspond to the faultless function of this micromirror 31 or group of micromirrors 31. The detection control unit 82 evaluates this way whether there is a functional failure of a micromirror 31 or some micromirrors 31 from the said group of micromirrors 31.

For the purposes of this invention, a functional failure of a micromirror 31 especially means a situation when a micromirror 31 is not rotated in the required way due to either a failure of the control unit 4, the entire micromirror 31 rotation mechanism, or any part that participates in the accomplishment of the command of the control unit 4 to rotate the micromirror 31 to the required position. Rotation in the required way means rotation in due time and at the same time rotation to the required position. In most applications, micromirrors 31 are rotated into two functional positions—the secondary position, referring to the position in which the micromirror 31 reflects light rays in the direction of the secondary light stream 10d, and the primary position, referring to the position in which the micromirror 31 reflects light rays in the direction of the primary light stream 10c. Another example of a functional failure of a micromirror 31 can be a situation wherein the micromirror has been rotated on command of the control unit 4, but due to a loss or a significant reduction of the reflective properties of the micromirror 31, light rays are insufficiently reflected by the micromirror 31. An example of a serious functional failure of micromirrors 31 is when in the low-beam mode, where certain micromirrors should be in the secondary position to prevent dazzling of road traffic participants, but instead these micromirrors remain in the primary position, e.g., due to being “stuck”.

The detection system of a failure of micromirrors 31 can be calibrated and used in the production stage already to ensure or verify its optimal functionality.

Due to a limited scanning frequency of micromirrors 31 (e.g., 60 Hz) and the number of micromirrors 31 in a mirror unit 3 (e.g., 1,000,000), this scanning sequence may take a very long time. Therefore, as indicated above, detection can also be carried out in such a way that the sequence is run in larger blocks or groups of micromirrors, e.g. 10×10 micromirrors 31, while a small part of the light can be directed to the detection unit 8 to confirm proper functioning of the micromirrors 31, and all the micromirrors 31 of the mirror unit 3 can be checked gradually.

The system supports autodiagnostic functions during a drive, e.g., in the high-beam light function mode, when all the micromirrors 31 direct light onto the carriageway and individual micromirrors 31 (groups of micromirrors 31) are gradually tilted towards the absorber 72 for diagnostic purposes.

The detection of light in the detection unit 8 does not directly check the condition of the output light stream 10e captured in the light image 6, but it verifies the ability of individual micromirrors 31 to direct light that should not be present in the light image 6 and thus in the output light stream 10e towards the absorber 72. If a micromirror 31 or some micromirrors 31 are found to be non-functioning, i.e., the mirror unit 3 exhibits a failure, suitable measures can be initiated accordingly (e.g. notifying the driver of the lighting fault, changing the lighting mode, deactivating it, etc.).

The detection system of a failure of micromirrors in a DMD mirror unit, if used in the projector system of a motor vehicle headlight, makes it possible to, e.g., detect failures of micromirrors in due time that would otherwise mean dangerous dazzling of road traffic participants without timely detection. The testing sequences can be activated during a regular maintenance check of the vehicle or during a periodic roadworthiness check.

### LIST OF REFERENCE MARKS

1—light unit
2—primary optical system
3—mirror unit
4—control system
5—secondary optical system
6—light image
7—absorption unit
8—detection unit
10—light ray
10a—coherent or incoherent light
10b—main light stream
10c—primary light stream
10d—secondary light stream
10e—output light stream
11—diode
31—micromirror
61—segment (of the light image 6)
62—unlit part (of the light image 6)
71—tertiary optical system
72—absorber
81—optical sensor
82—control unit (of the detection unit 8)

1. A detection system of an operational failure of micromirrors in a DMD mirror unit, especially in a projector system of a motor vehicle headlight, comprising a light unit to emit coherent or incoherent light, a primary optical unit for light processing that at least one main light stream exits from that is directed to the mirror unit comprising micromirrors arranged in a rotary way whose angle of rotation is controlled by a control system in such a way that the light that is intended to produce a light image at a particular moment is reflected by respective micromirrors out of the mirror unit in the form of a primary light stream while the part of the light that should not be used to produce the light image at the particular moment is reflected by other micromirrors in the form of a secondary light stream into an absorption unit, wherein the absorption unit is configured for an output of at least a part of light rays that are directed to the absorption unit by the mirror unit into a detection unit comprising an optical sensor to detect light rays, and a control unit connected to the control system to process and evaluate a signal from the optical sensor, in a defined scanning sequence in which individual micromirrors or simultaneously an entire group of micromirrors are rotated by the control system to establish a functional failure of an individual rotated micro-mirror or a functional failure of some micromirrors from the rotated group of micromirrors if it is evaluated that a state detected by the optical sensor does not correspond to a known light characteristic that the respective micromirror or group of micromirrors would exhibit in its flawless operation.

2. The detection system according to claim 1, wherein that the control unit is part of the control system.

3. The detection system according to claim 1, wherein the control unit is part of the detection unit.

4. The detection system according to claim 1, wherein the absorption unit comprises a tertiary optical system comprising at least one diffractive optical element to direct light rays from the tertiary optical system partly to an absorber, and partly to the detection unit.

5. The detection system according to claim 1, wherein the absorption unit comprises a tertiary optical system comprising at least one diffractive optical element to direct light rays from the tertiary optical system to an absorber, a part of light rays received by the absorption unit being sent from the absorption unit to the detection unit.
